(19) United States
(12) Patent Application Publication
(10) Pub. No.: US 2018/0209923 A1
(43) Pub. Date: Jul. 26, 2018

(54) METHOD OF NEUTRON TOMOGRAPHY

(71) Applicant: LANCASTER UNIVERSITY BUSINESS ENTERPRISES LTD, Lancaster (GB)

(72) Inventors: Malcolm Joyce, Lancaster (GB); Stewart Agar, Kendal (GB); Edmund Colley, Newark (GB); Miriam Colling, Lancaster (GB); Joseph Dykes, Guiseley (GB); Pheovos Kardasopoulos, Birmingham (GB); Kate Mitton, Liverpool (GB); Michael Aspinall, Lancaster (GB)

(21) Appl. No.: 15/748,051

(22) PCT Filed: Jul. 21, 2016
(86) PCT No.: PCT/GB2016/052208

§ 371 Date: Jan. 26, 2018

(30) Foreign Application Priority Data
Jul. 27, 2015 (GB) 1513188.1

(51) Int. Cl. G01N 23/05; G01N 23/046

(52) U.S. Cl. CPC G01N 23/05; G01N 23/046

(57) ABSTRACT

A method of obtaining neutron tomography images of a workpiece (201), by means of a neutron source (101) and a plurality of neutron detectors (107), where the neutron source is an isotopic source containing less than one gram of radioactive isotope(s); the workpiece is up to 300×300×300 mm in size; and measurements to generate at least one tomography image of a workpiece take one hour or less to obtain.

The present invention concerns neutron tomography, and in particular neutron tomography advantageously using a low emission source,

Neutron radiation offers a range of properties for radiography complementary to other means such as X-rays. Neutron radiation has no electrostatic interaction with matter, so its scattering properties are largely independent of the atomic number of the elements constituting the material under scrutiny. Conversely, neutrons interact more with lighter isotopes, especially hydrogen and to a lesser extent, carbon, nitrogen, oxygen and calcium (abundant constituents of living organisms, and coincidentally also abundant in materials used in civil engineering).

Neutrons have been used in the past to probe a variety of materials. However the systems known for such purposes require very large facilities for generation of neutrons, such as a nuclear reactor, particle accelerator or neutron generator. This is because a high emission source (for example see JPH0269644 (Toshiba)) has traditionally been required in order to achieve satisfactorily short acquisition times and image resolution. As well as the large generation facilities this has the further disadvantage of requiring heavy shielding and strict radiological control procedures for all staff.

Portable X-ray radiography has been used for assessing critical welds in steam-raising plant. Health and safety practice usually requires a temporary controlled area to be established. For many applications, particularly in civil engineering such measures may be either undesirable and/or impossible.

Traditional methods (see for example JPH0269644 (Toshiba)) use slow or cold neutrons. Neutrons with energies in this range generally have the advantage of stronger interactions with matter, but relatively little penetrating power, so are limited to small scale applications such as micro-crystallography.

Fast neutrons in contrast have good penetration properties, tend to be scattered by light isotopes but until recently have been difficult to detect. Fast neutrons have recently become available for tomography because of the advent of low-hazard materials with good detection characteristics and related ultra-fast signal processing.

It is known to use a source of low energy neutrons that interact with a workpiece to produce high energy gamma radiation and then to detect that gamma radiation. Unlike the present invention, such methods (see for example U.S. Pat. No. 5,114,662A (Gozani)) use gamma radiation for imaging, whereas the present invention uses neutrons for imaging.

It is an objective of the present invention to overcome or mitigate the disadvantages of traditional neutron radiography.

It is a further objective of the present invention to provide a method of neutron radiography using only human-portable components.

The present invention is a method of obtaining neutron tomography images of a workpiece, by means of a neutron source and a plurality of neutron detectors, where the neutron source is an isotopic source containing less than one gram of radioactive isotope(s); the workpiece is up to 300×300×300 mm in size; and measurements to generate at least one tomography image of a workpiece take one hour or less to obtain.

The neutron source may emit on average fewer than twenty million neutrons per second. The neutron source may emit fast neutrons. Each neutron detector may be a scintillation counter with its own photomultiplier tube operably connected to a pulse-shape discrimination analyser.

According to the present teachings, a fast neutron is considered to have an energy of above 500 keV, generally above 600 keV suitably above 650 keV, typically around 700 keV, or more.

The present invention may additionally employ at least one of the following items: a collimator, a means of manipulating the position and orientation of the workpiece, electronics to collect neutron counts, computing means to process the neutron counts into tomography images, and a control system to automate positioning of the workpiece and collection of neutron counts.

Each item of equipment employed by the present invention may be human-portable, in that no item has a dimension exceeding one metre and no item has a weight exceeding thirty kilograms.

The radioactive isotope(s) may comprise(s) at least californium. Alternatively or additionally, the radioactive isotope(s) may comprise(s) at least americium.

The scintillation counters may count substantially only neutrons with energies above 500 keV.

Tomography images obtained may be two dimensional cross sectional representations of a three dimensional object In yet another aspect, the present teachings include a kit, where the kit includes the apparatus/equipment of the present teachings, or the components necessary to form the apparatus/equipment of the present invention, and instructions for use thereof.

According to a further embodiment, there is provided a system for performing the methods disclosed herein. The system can include the equipment as disclosed herein. The system may include an analytical instrument used to automate positioning of the workpiece and collection of neutron counts. The system also can include a suitably programmed computer for carrying out one or more steps of the methods. For example, the suitably programmed computer can carry out or assist in one or more of control of the positioning of the workpiece, collection of neutron counts, processing the neutron counts into tomography images, and equivalents thereof.

Throughout the Application, where apparatus or equipment are described as having, including, or comprising specific components, or where processes are described as having, including, or comprising specific process steps, it is contemplated that equipment of the present teachings also consist essentially of, or consist of, the recited components, and that the processes of the present teachings also consist essentially of, or consist of, the recited process steps.

In the Application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of an equipment, an apparatus, or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

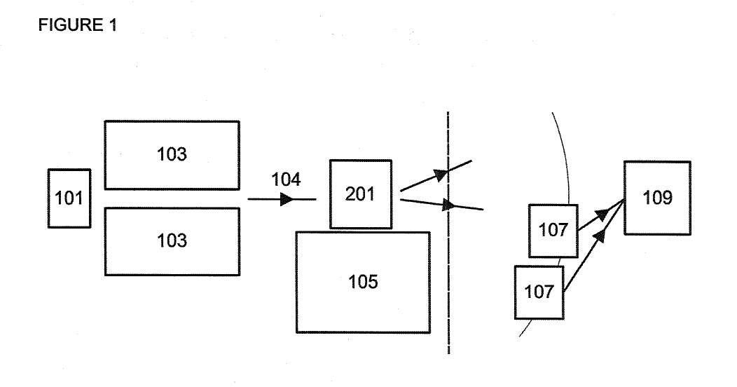

FIG. 1 shows a schematic representation of the equipment used by an example embodiment of the present invention. In FIG. 1 the portion left of the dashed line shows an elevation, and the portion right of the dashed line shows a plan view.

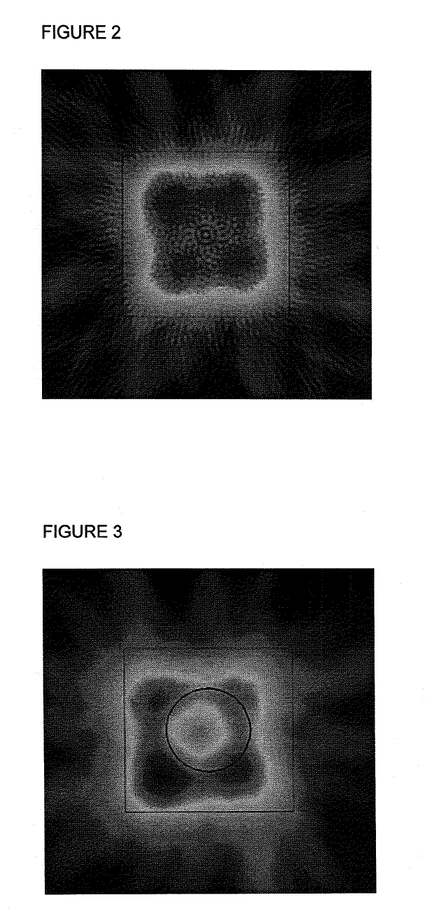

FIG. 2 shows a tomography image for a concrete cuboid based on acquisition over 16 rotations and 20 translations, with total measurement time of one hour.

FIG. 3 shows a tomography image for a concrete cube with a central steel pipe based on acquisition over 12 rotations and 15 translations, with total measurement time of one hour.

Referring to FIG. 1, the present invention comprises at least the following components:
A low emission neutron source (101),
Liquid scintillator detectors (107),
Electronics to process scintillator output (109).

Further referring to FIG. 1, the present invention may additionally comprise:
A collimator (103) providing a shaped neutron beam (104),
A positional manipulator (105) offering vertical, rotational and horizontal displacement of a workpiece (201),
An electronic event counter (111),
A computer running dedicated acquisition and control software (113).

A suitable neutron source (101) is a solid state source with an average neutron emission rate of fewer than 20 million neutrons per second (into 4π steradians). Such sources (101) are available commercially.

Use of such a source (101) is a major advance over the traditional use of large facilities-based methods of neutron generation. A suitable source (101) may contain less than one gram of the active isotope(s). Quantities of the order of micrograms may be sufficient. Such a source is therefore human-portable.

The present invention is able to benefit from such an advantageous source by making innovative use of materials in the detectors (107) and using ultra high speed electronics (109).

A collimator (103) may be used to form a neutron beam (104) of appropriate shape. The effective collimation of neutrons is not trivial given their tendency to reflect and be slowed down by light elements, and absorbed strongly by a few, specific isotopes.

The shape of the collimator (103) is determined by the disposition of the detectors (107). For example if a linear array of detectors (107) is used, a fan shaped beam (104) is preferred, and if a two dimensional array of detectors (107) is used, a cone shaped beam (104) is preferred.

A variety of materials may be suitable for use as a neutron collimator (103) including water, high-density polyethylene, tungsten, iron or Perspex®. Where portability is required, high-density polyethylene is preferred as being relatively cheap and easy to machine and to deploy.

Because the purpose of tomography is to provide cross-sectional images of the macroscopic structure of a workpiece (201), rather than microstructural analysis, it is preferable to rotate the workpiece (201) to a variety of contrasting positions. This may conveniently be achieved by a positional manipulator (105) such as a turntable or other form of manipulator, preferably automated.

Neutrons pass through the workpiece (201) and are selectively absorbed and/or scattered, and some are detected by each of a plurality of detectors (107).

Multiple neutron detectors (107) may be used to capture neutrons at various angular displacements in order to allow image construction. For clarity in FIG. 1 only two detectors (107) are shown. In practice more are deployed, arranged along a circular arc or spherical surface.

Discriminating analysers (109) are preferably used, operably connected to collect events from the detectors (107) and to discriminate between arriving neutrons and gamma photons. Counter modules (111) may be further operably connected to count the neutrons from each detector (107).

A control system (113) may be used to automate the tomography acquisition process, namely one or more of the steps or processes below:
To interpret a command file governing for example the start/end points and the size of increment as set by the user for workpiece (201) movement,
To generate control signals to actuate the positional manipulator (105) to the required sequence of positions,
To count (when the workpiece (201) is stationary) neutron events for a specified period of time,
To end each count, reposition the workpiece (201) and start a new count.
Finally, to process the count data into a format suitable for separate analysis that generates the tomography images.

Once data collection is complete, tomography image generation may be performed by any suitable software package.

An example embodiment will now be described in detail:

In the example embodiment the neutron source (101) is a californium (²⁵²Cf) source with an emission rate of 15 million neutrons per second (into 47c steradians), giving an associated neutron dose rate at 1 metre distance of 163 microsievert per hour and an estimated gamma ray dose rate of about 10 microsievert per hour (ignoring scatter).

In order to obtain high quality tomography with low neutron emission, it is essential to match the source (101) and detection system (107, 109). For the selected detectors (107, see below for full details) the californium source (101) selected has a suitable energy spectrum with an average neutron energy of about 2.1 MeV and a most-probable neutron energy of about 700 keV, thus falling within the usual definition of fast neutrons. The selected detectors (107) have a detection profile which falls rapidly for neutron energies below about 500 keV.

Neutrons that are scattered lose energy, so scattered neutrons from the selected source (101) have a greater likelihood of having energies below the low-energy cut-off for the detectors (107) than neutrons from other higher energy sources. Selection of this source (101) and these detectors (107) thus significantly reduces the background noise from scatter.

In the present invention, use of higher-energy neutron sources such as americium-beryllium would be expected to result in tomography images of lower-quality.

In the example embodiment a fan-shaped beam (104) of neutrons is formed using a collimator (103). Two pieces of collimator material are placed horizontally, one above the other to leave a thin, parallel aperture between them through which the horizontal fan (104) of neutrons is formed. The dimension of the collimator (103) is matched to the size of the workpiece (201) in order to optimise the ratio of length-to-depth and to minimise the distance from workpiece (201) to detector (107), and thus to ensure a high spatial resolution in the tomography images.

High-density polyethylene is preferred for the collimator (103), with a central parallel aperture of 3 mm. This is created by separating two 500×300×180 mm slabs (weight˜27 kg each) with several 3 mm spacers (giving total height of 363 mm).

Degradation of the beam profile (104) by scattering in a hydrogenous collimator is not significant in this embodiment because (as discussed above) the response of the selected detectors (107) ignores the majority of scattered neutrons. This simplifies the design of the collimator (103) and removes the need for exotic thermal neutron absorber materials, such as gadolinium, bismuth and cadmium that are often necessary in other applications.

In the example embodiment the functions of a positional manipulator (105) are provided by a turntable (105) with additional translational capacity. This is manufactured mostly in aluminium (for light weight and to minimise neutron interaction). High-speed motors are used to adjust the position of the turntable (105) between measurements while maintaining sufficient accuracy to ensure the minimum of movement (slip and backlash) at each position. Construction of such equipment is well known to those skilled in mechatronics.

The turntable (105) is designed to be human-portable but sufficiently robust to withstand transport between sites and to be rigid during operation. As well as rotation, the turntable provides horizontal translation of 100 mm and vertical translation of 110 mm to enable a maximum size of workpiece (201) of dimension 300 mm with full 360° freedom of rotation.

Horizontal and vertical movements are each provided by lead screws actuated with a stepper motor (Igus, Germany); with minimum step size of 0.0075 mm in the vertical, and 0.02 mm in the horizontal. The rotational movement is provided by a timing belt and pulley mechanism giving a minimum angle of 0.27° per step consistent with a tolerance required for a quality image of at least 1°.

In the example embodiment seven VS-1105-21 EJ309 scintillation detectors (107) (Scionix, Netherlands) of cell dimensions 100×100×120 mm are used, containing EJ309 scintillant (Eljen Technologies, TX), arranged in a horizontal circular arc to give substantially equal distances to the workpiece (201).

Each individual detector (107) is placed in a vertical arrangement. This geometry preserves the isotropy of the neutron flux, such that in the absence of a workpiece (201) each detector (107) measures identical neutron flux irrespective of position. Each detector (107) has its own photomultiplier tube of type 9821 FLB (ADIT Electron Tubes, Sweetwater, Tex.) and the high-voltage and anode signal cables are routed to analysers (109).

Importantly the use of the selected liquid scintillator and direct photo-multiplication makes the present invention highly efficient and able to benefit from the low emission source (101) and the presence of fast neutrons. Traditional techniques of detection first thermalise neutrons, convert them to photons using a phosphor and then detect photons using a charge coupled device. Each stage of such conversion reduces efficiency; hence the traditional need for high emission neutron sources.

Preferably extra detectors (107) are deployed in position to enable rapid substitution should any difficulties with stabilisation of any detector. For example in this embodiment two additional detectors are deployed as well as the stated seven,

In the example embodiment MFAx4.3 analysers (Hybrid Instruments Ltd) (109) provide real-time pulse-shape discrimination (“PSD”) together with high-voltage control and PSD threshold setting. This enables neutron events from each detector (107) to be discriminated from gamma photons in 333 ns with a jitter of 6 ns and an event throughput of three million per second. Neutrons and gamma photons are discriminated in real time as they are collected and a 50 ns TTL pulse provided for each one on separate outputs from the analyser (109).

This embodiment uses only the neutron events, input directly into the counter system (111). A separate channel is provided for each of the seven detectors (107). A counter module (111) counts the 50 ns TTL pulse signals produced by the MFAx4.3 analysers (109) at high frequency (maximum 3 MHz). This gives a capacity of up to 64 counting channels (32 neutron and 32 gamma photon signals) and affords future expansion to larger arrays of detectors (107).

In the present embodiment the control system:
interprets a LabVIEW® command file to actuate the turntable,
when stationary, counts neutron events for a specified period of time,
at the end of the period reports the count and moves to the next position, and
processes the count data and transfer them to a PC.

The example embodiment uses an open-loop control mode with three DC stepper motors selected to drive the pulley system and the lead screws. Commercially-available stepper motor drive circuits (Quasar Electronics) are used, actuated by a microcontroller (Arduino.cc). The microcontroller interprets the user-configured settings from the LabVIEW® command file and provides the corresponding signal stimulus to the control motor circuits. Once the turntable (105) is stationary, a microcontroller in the counter circuitry (111) counts the neutron events, stops the count and transfers the count data to the LabVIEW® interface ready for image generation. It then moves the turntable (105) to the next position before beginning to count again.

Various approaches and algorithms for image generation from neutron counts may be used, as well known to the skilled person. In the example embodiment, image generation is performed offline in MATLAB®.

In the example embodiment, an imaging strategy is used comprising small movements of the workpiece along an axis perpendicular to the neutron paths, at each rotational position. This produces a set of projections that are added together to produce a final image, providing greater resolution for a given workpiece (201) than would otherwise be achievable.

The present invention has been operated at the UK National Physical Laboratory (“NPL”) at Teddington. The source (101) was an unmoderated ²⁵²Cf source. Single neutron events were fed to the analysis instrumentation (109), and synchronized with the capture of data at each specific position of the workpiece (201).

Each workpiece was mounted on a rotary table (105) to allow it to be moved throughout 360° in the plane parallel with the floor and over a plurality of positions in the horizontal plane.

Before use, the detectors are preferably calibrated to ensure uniform sensitivity across the detector array (107). A radioactive caesium source (¹³⁷Cs) may be used for such calibration. This isotope is suitable because it decays via beta-emission to an excited state of ¹³⁷Ba which subsequently decays via the emission of a single 662 keV gamma photon. This mono-energetic emission enables the response of each detector (107) to be standardised by adjusting the high-voltage supply level to each photomultiplier tube (so that they produce the same output). Once this is completed, tomography of a workpiece (201) may begin.

Two workpieces (201) were prepared, both of concrete: the first a solid cuboid and the second a cube with a hollow vertical steel pipe through the centre. The concrete for both was mixed with a vibrator to ensure uniform composition and then formed with a mould. Curing was prolonged by covering each workpiece (201) with a polythene sheet. The dimension of the cuboid is 100×100×30 mm and the cube with the pipe insert has 100 mm edges with a pipe of 50 mm diameter.

These geometries were chosen to show the differentiation of rectilinear and circular forms, and between solid and hollow workpieces.

FIG. 2 shows a visual representation of experimental results for the concrete cuboid workpiece based on acquisition over 16 rotations and 20 translations, with total measurement time of one hour.

FIG. 3 shows a visual representation of experimental results for the concrete cube with steel pipe based on acquisition over 12 rotations and 15 translations, with total measurement time of one hour.

In each case the true dimensions of the objects have been superimposed.

As is well known, tomography results may be displayed in a variety of formats. These include without limitation tables of data and synthetic images. Such image formats may include means of showing intensity of radiation, such as density plots, false-colour images and contour plots. Such images may be numerically processed to enhance the images by well-known means such as moving averages, data smoothing and many others as appropriate for each application.

By the use of reference data and/or images, the results may be augmented to show the detected presence of defects and/or impurities such as voids and/or inclusions within a workpiece.

Further if the workpiece itself contains an embedded neutron source (for example radioactive waste material) this may be observed as a bright spot in neutron images. Neutron tomography may therefore reveal the location of the embedded source within the workpiece, enabling more intelligent handing and/or re-processing. This application is enabled by the use of a method requiring only human-portable equipment such as may be provided by the present invention.

The results demonstrate effective neutron tomography with a low-dose neutron source and a small number of matched organic scintillation detectors. Useful data may be obtained in one hour or less that enables solid and voided workpieces to be discerned from one another.

The present invention may be used for in situ neutron tomography using human-portable equipment for use where traditionally the need for installed facilities (such as a reactor or accelerator-based source) has made this impossible.

While the present invention has been described in terms of several embodiments, those persons skilled in the art will recognise that the present invention is not limited to the embodiments and examples described, but can be practised with modification and alteration within the scope of the appended claims. The Description is thus to be regarded as illustrative instead of limiting.

1. A method of obtaining neutron tomography images of a workpiece, by means of a neutron source and a plurality of neutron detectors, where
the neutron source is an isotopic source containing less than one gram of radioactive isotope(s);
the workpiece is up to 300×300×300 mm in size; and
measurements to generate at least one tomography image of a workpiece take one hour or less to obtain.

2. A method as in claim 1 where the neutron source emits on average fewer than twenty million neutrons per second.

3. A method as in claim 1 where the neutron source emits fast neutrons.

4. A method as in claim 1 where each neutron detector is a scintillation counter with its own photomultiplier tube, operably connected to a pulse-shape discrimination analyser.

5. A method as in claim 1 additionally employing at least one of the following items: a collimator, a means of manipulating the position and orientation of the workpiece, electronics to collect neutron counts, computing means to process the neutron counts into tomography images, and a control system to automate positioning of the workpiece and collection of neutron counts.

6. A method as in claim 1 where each item of the equipment is human-portable, in that no item has a dimension exceeding one metre and no item has a weight exceeding thirty kilograms.

7. A method as in claim 1 where the radioactive isotope(s) comprise(s) at least californium.

8. A method as in claim 1 where the radioactive isotope(s) comprise(s) at least americium.

9. A method as in claim 1 any of claims d to g where the scintillation counters count
substantially only neutrons with energies above 500 keV.

10. A method as in claim 1 where tomography images obtained are two dimensional cross sectional representations of a three dimensional object.
